(19) United States
(12) Patent Application Publication
(10) Pub. No.: US 2024/0012903 A1
(43) Pub. Date: Jan. 11, 2024

(54) Method for Executing a Program on a Data Processing Device

(71) Applicant: Infineon Technologies AG, Neubiberg (DE)

(72) Inventors: Roland Ebrecht, Augsburg (DE); Gerd Dirscherl, München (DE); Stefan Hackenberg, Augsburg (DE); Florian Mendel, München (DE); Stefan Witossek, Augsburg (DE)

(21) Appl. No.: 18/217,693

(22) Filed: Jul. 3, 2023

(30) Foreign Application Priority Data
Jul. 6, 2022 (DE) 102022116869.7

(51) Int. Cl. G06F 21/51

(52) U.S. Cl. CPC G06F 21/51

(57) ABSTRACT

A method for executing a program on a data processing device, the method comprising storing multiple program instructions and data to be processed by a processor of the data processing device in one or more memories of the data processing device; receiving, from an external data processing device, a reference value for a check of the multiple program instructions; computing a check value from the multiple program instructions for the check by way of the data processing device when the program instructions are loaded from the one or more memories into an instruction buffer memory of the data processing device or by way of read access to the instruction buffer memory after the program instructions have been loaded into the instruction buffer memory from the one or more memories; and executing at least some of the program instructions if the check value matches the received reference value.

### TECHNICAL FIELD

Example embodiments relate in general to a method for executing a program on a data processing device.

### BACKGROUND

In security-critical applications, such as in many applications for chip cards, microcontrollers are intended to execute only program code whose integrity has been successfully checked, due to security and reliability requirements.

However, requirements in terms of the execution time of program code, in particular at startup, such as when starting NFC (near-field communication) communication using a chip card, may prevent the use of various program code checking approaches. One typical approach requires, for example, reading the program code twice (once to check it, and once more to execute it), computing a check value (for example a checksum or a signature), and comparing the check value with a reference value. This process may take too much time in practice.

Approaches for guaranteeing the integrity of executed code with a small time overhead are therefore desirable.

### SUMMARY

Disclosed herein are techniques, apparatuses, and systems directed to this problem. According to one example embodiment, a method for executing a program on a data processing device, comprising storing multiple program instructions and data to be processed by a processor of the data processing device in one or more memories of the data processing device, the data processing device receiving, from an external data processing device, a reference value for a check of the multiple program instructions and storing the reference value in the data processing device, computing a check value from the multiple program instructions for the check by way of the data processing device when the program instructions are loaded from the one or more memories into an instruction buffer memory of the data processing device or by way of read access to the instruction buffer memory after the program instructions have been loaded into the instruction buffer memory from the one or more memories, and the processor executing at least some of the program instructions if the check value matches the received reference value.

According to a further embodiment, provision is made for a data processing device in accordance with the method described above. According to a further embodiment, provision is made for a data processing system that contains the data processing device and the external data processing device that is configured to generate the reference value and to supply it to the data processing device. It should be noted that embodiments that are described in connection with the method apply analogously to the data processing device and vice versa.

### BRIEF DESCRIPTION OF THE FIGURES

The figures do not reflect the actual proportions but are intended to illustrate the principles of the various example embodiments. Various embodiments are described in detail below with reference to the following figures.

FIG. 1 shows a data processing device.

FIG. 2 shows a data processing device according to one embodiment.

FIG. 3 illustrates a program code check in the architecture of FIG. 2.

FIG. 4 shows an embodiment in which a checking unit is arranged between CPU and instruction cache memory.

FIG. 5 shows a variant in which the CPU performs the comparison between a check value supplied by the checking unit and a reference value.

FIG. 6 illustrates the checking of a further program code portion following the check from FIG. 5.

FIG. 7 shows a variant in which the checking unit is implemented as part of the instruction cache memory and carries out the check value computation and the comparison with the reference value.

FIG. 8 shows a variant in which, for each of multiple program code portions, a respective reference value is contained together with the program code portion in a non-volatile memory.

FIG. 9 illustrates an embodiment in which each program code portion is provided with a respective reference value that is stored together therewith (that is, as part thereof).

FIG. 10 illustrates an embodiment in which a first program code portion is provided with the reference value for a second program code portion and the second program code portion is provided with the reference value for a third program code portion.

FIG. 11 shows a data processing device according to one embodiment.

FIG. 12 shows a flowchart illustrating a method for executing a program on a data processing device.

### DETAILED DESCRIPTION

The following detailed description relates to the attached figures, which show details of example embodiments. These example embodiments are described in such great detail that a person skilled in the art is able to carry out the invention. Other embodiments are also possible and the example embodiments may be modified in structural, logic and electrical terms without departing from the subject matter of the invention. The various example embodiments are not necessarily mutually exclusive; rather, various embodiments may be combined with one another to produce new embodiments. Within the scope of this description, the terms “linked”, “connected” and “coupled” are used to describe both a direct and an indirect link, a direct or indirect connection, and direct or indirect coupling.

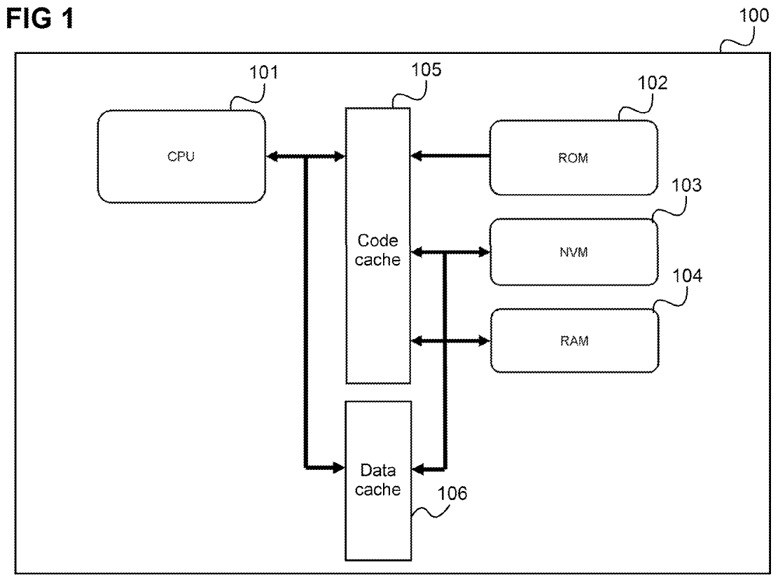

FIG. 1 shows a data processing device 100.

The data processing device 100 has a CPU (central processing unit) 101 and various memories, here a ROM (read-only memory) 102, a non-volatile memory (NVM) 103 and a RAM (random access memory) 104.

An (instruction) cache memory (or generally an (instruction) buffer memory for instructions), shown in FIG. 1 as code cache 105, is provided between the memories 102, 103, 104. (Note that the terms “instruction cache” and “code cache” are used interchangeably herein.) This speeds up the execution of instructions that are stored in the memories 102, 103, 104 by the CPU 101, since the CPU 101 is typically able to execute instructions more quickly than these are able to be supplied (individually) from the memories 101, 102, 103.

Provision is made similarly for a (data) cache memory 106 for data, here between NVM 103 and CPU 101 and RAM 104 and CPU 101, which enables fast processing of data by the CPU 101.

When the data processing device 100 is started (for example when a smart card is introduced into a reader field), the CPU 101 executes starting program code (that is, program instructions for starting the data processing device) that is stored in the ROM 102 (or else in the NVM 103 or a combination of both).

The CPU 101 executes this start code in a special starting mode. It then switches to a user mode in which it retrieves user program code from the NVM 103 and executes said code.

However, program code stored in the NVM 103 is able to be changed, in particular by an attacker. Therefore, in the case of security-critical applications, it is possible to check the integrity of program code from the NVM 103 by executing corresponding program code from the ROM 102 (which is not able to be changed and may therefore be assumed to be secure) before it is executed. This may be achieved, for example, by virtue of the program code in the ROM 102 making provision to compute a checksum (generally a check value that is computed in accordance with a predefined check value computing function, such as for example including a hash value or a signature) for the program code in the NVM 103 that is intended to be executed and comparing this with a saved reference value stored in the data processing device. The CPU 101 executes the program code from the NVM 103 only if the check value matches the reference value.

The program code that carries out the check may also be stored (at least in part) in the NVM 103, but is in this case checked before it is executed so that it is trustworthy.

The program code in the NVM 103 is checked for example in blocks (that is, each block has its own associated reference value for such a check).

If this procedure is adopted, in order to check the user program code, this is first loaded into the data cache memory 106, since the CPU 101 processes it as data in accordance with the check program code from the ROM (which is loaded into the instruction cache memory 105). In the event of a successful check (that is, the check value is the same as the reference value), the user program code is then treated as instructions and loaded into the instruction cache memory 105 for execution thereof. The user program code is thus loaded into a cache memory twice. To speed up the process, the checksum may also be generated by a hardware circuit (that is, not by way of a checking program executed by the CPU 101). However, in this case, additional data transfers between the CPU 101 and this hardware circuit (for example a peripheral module) are necessary.

For applications in which little time is available, for example when a user program has to be executed within the short time for which a smart card is located in an NFC (near-field communication) field, a program code check is therefore not possible (or at least not in full) in such a procedure.

According to various embodiments, a description is given of an approach that enables a faster program code integrity check than the approach described above with reference to FIG. 1.

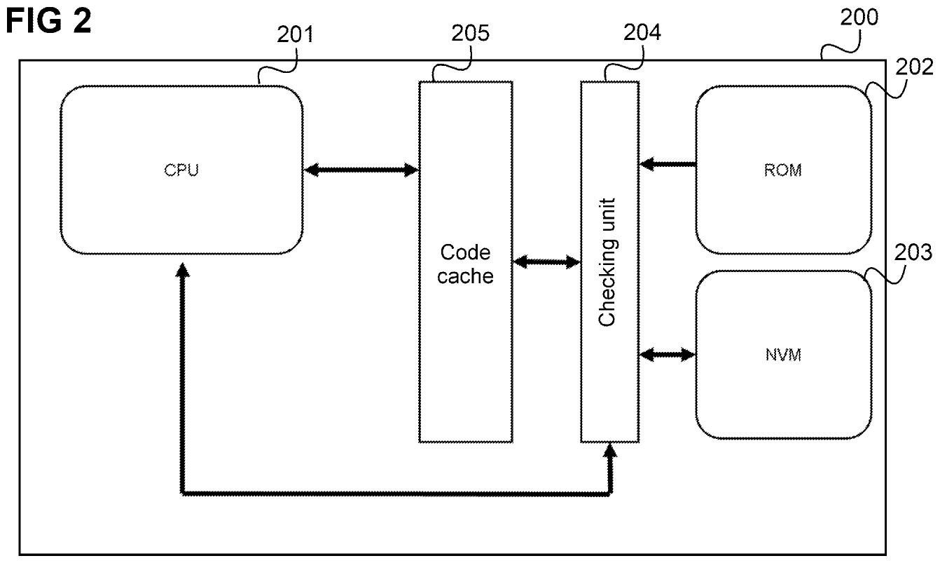

FIG. 2 shows a data processing device 200 according to one embodiment.

The data processing device 200 may be any type of data processing device, such as for example a computer or a smartphone, a chip card (with any form factor) or a control apparatus (for example with a microcontroller) that is used in a vehicle, for example.

Similarly to the data processing device 100, the data processing device 200 has a CPU 201, a ROM 202 and an NVM 203. The data processing device 200 may also have a RAM. The data processing device 200 furthermore has a data cache memory. However, since this is not involved in the program code check, it is not shown in FIG. 2. The ROM 202 and the NVM 203 are connected to the CPU 201 via a checking unit 204 and an instruction cache memory (similar to the instruction cache memory 105 for speeding up the execution of instructions), shown in FIG. 2 as code cache 205.

The checking unit 204 may be implemented at least in part as a (dedicated) hardware circuit, or it may also be a software-implemented checking engine (whose program instructions are stored for example in the ROM 202) that is executed by the CPU 201 or else another programmable component of the data processing device 200. The term “checking circuitry” may be used to refer to either sort of implementation or to a combination thereof. i.e., a dedicated hardware circuit, or a processing circuit configured with program instructions to carry out the checking operation, or some combination of both.

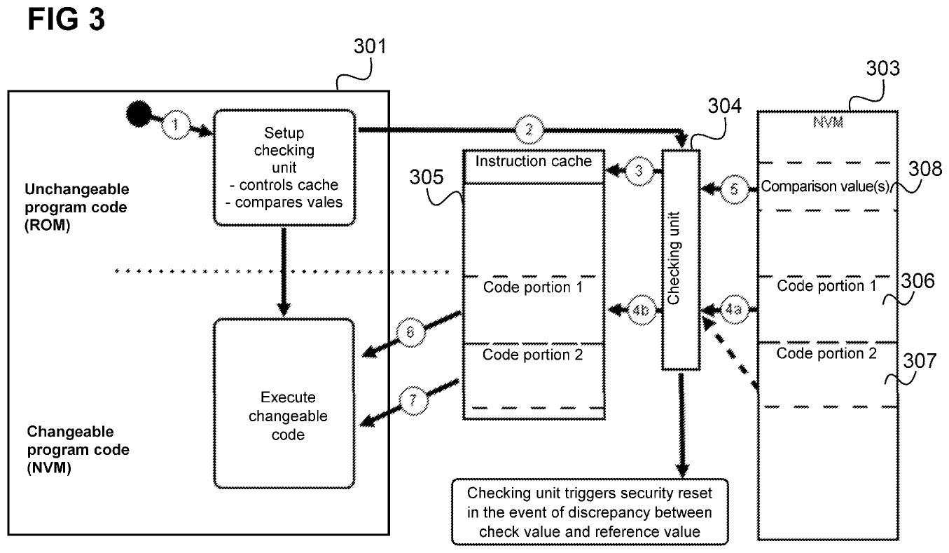

FIG. 3 illustrates a program code check in the architecture of FIG. 2.

The program code to be checked is stored in an NVM 303, which corresponds to the NVM 203, and consists for example of two program code blocks 306, 307.

FIG. 3 also illustrates a checking unit 304 corresponding to the checking unit 204 and an instruction cache memory 305 corresponding to the instruction cache memory 205, and the tasks of the CPU 301.

The sequence illustrated by the circles numbered (1) to (7) in FIG. 3 is described in more detail below.

In (1), the data processing device is started by executing starting program code from the ROM 202, as described with reference to FIG. 2.

In (2), the CPU 301 initializes the checking unit 304 for the program code check.

In (3), the checking unit 304 configures the instruction cache memory 305 for aiding the program code check.

In (4a) and (4b), the instruction cache memory 305 reads in the first program code portion 306 to be checked via the checking unit 304 and locks this program code portion 306 in the instruction cache memory 305 (that is, a cache lock is implemented for the first program code portion 306 in the instruction cache memory 305).

The checking unit 304 in the process (that is, while the program code portion 306 is being read in via it) computes the check value for the first program code portion 306.

In (5), the checking unit 304 reads the reference value for the first program code portion 306 and compares the read reference value with the computed reference value.

If the check is successful (that is, check value same as reference value), then the CPU 301 executes the first program code portion 306 in (6). If the CPU 301 has executed the first program code portion 306 and it is necessary to execute a further program code portion, here the second program code portion 307, (4a), (4b) and (5) are also performed for the second program code portion 307 and the CPU 301 executes the second program code portion 307 (following successful checking of this program code portion as well).

If the checking unit 304 detects a discrepancy between check value and reference value for a program code portion, then it outputs a (fault or alarm) signal, for example to reset (that is, trigger a security reset of) the data processing device 200. The CPU 301 may execute the respective program portion even in the event of a discrepancy (that is, a discrepancy may be accepted), with an appropriate response to the signal then however taking place, for example taking a security measure such as for example checking processing results.

If all program code portions have been successfully checked and executed, the checking unit may be deactivated. This may be brought about by the last program code portion of the respective program.

Since, in the procedure described with reference to FIG. 3, the program code 306, 307 to be checked needs to be loaded into a cache memory only once to be checked and executed, because it is checked when it is loaded into the instruction cache memory 304 (or, as an alternative, is checked in the instruction cache memory 304), faster checking and execution of program code is possible in comparison with the procedure described in FIG. 2. No additional data transfers or memory resources (such as NVM or RAM) are necessary for the procedure described with reference to FIG. 3.

Security is also increased since the program code is checked when it is loaded into the instruction memory 304 and no further loading, during which or prior to which it could be changed again, takes place. The program code portions, at least until they are executed, are locked in the cache.

In the event that a program portion that has already been checked and executed once has to be executed once more, markings (for example a flag) may be provided for the program portions, said markings making it possible to mark such a program portion as already checked. In this case, it is not necessary for the checking unit 304 to check the program portion again.

The instruction cache memory 304 may also be another (buffer) memory or memory region that speeds up the execution of program code, such as for example a TCM (tightly coupled memory), for example a tightly coupled RAM, in particular a memory with a dedicated connection to the CPU 301 for transmitting program instructions. This memory (or memory region), which is also referred to as instruction buffer memory, may be a memory (or memory region) dedicated to instructions.

A key value that is stored on the data processing device 200 and that is represented for example by logic cells concealed under other logic cells may be used in the computing of the check value. This makes it possible to prevent an attacker being able to compute the correct check value for malicious code. This secret key value is used to compute the reference values (which takes place for example at the manufacturer). The check value computing function may also be based on asymmetric cryptography, that is, the check value is a signature that is computed by way of a private (secret and for example concealed) key, and the comparison with the reference value (that is, the checking of the correctness of the check value) is performed using a public key (for example stored in the firmware).

The reference value may for example be stored in a write-protected region 308 of the NVM 303 (that is able to be written to for example only by the manufacturer, by way of a flash loader or for which write access is blocked in user mode). The reference values may in particular be located in other memory regions than the program code to be checked.

If the checking mechanism described above is used, it is not necessary to use an EDC (error detection code) to protect program code in the memory (but this may also be provided as an additional measure, for example with a reduced number of check bits). It is thus possible to reduce the overhead for protection, for example of the NVM 303, since larger blocks (multiple memory cells instead of one per EDC) are protected by a single reference value. It is thus possible to achieve a better ratio between program code and reference values. Since it is thereby possible to save on overhead, provision may then also be made for a more complicated check value computation (with check values having a high number of bits), thereby making it possible to guarantee high security. The number of bits may also be optimized better, since EDC is applied to the complete memory and the checking mechanism described above may also be applied to only a small code region. Furthermore, the above checking mechanism, in contrast to EDC, offers protection against the insertion of malicious code by an attacker through internal write access.

The checking mechanism may be aided by an MMU (memory management unit) and/or by an MPU (memory protection unit) that is or are provided in the data processing device.

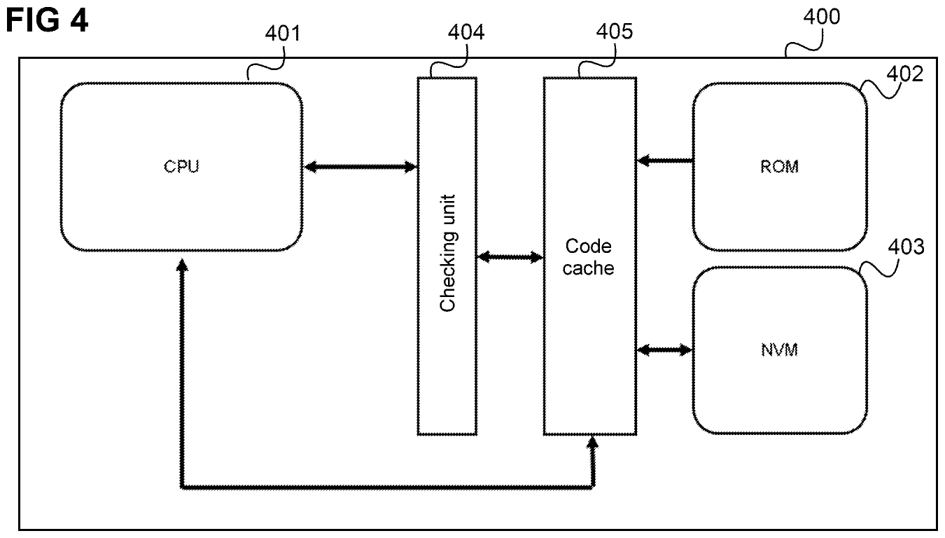

FIG. 4 shows an embodiment in which the checking unit 404 is arranged between CPU 401 and instruction cache memory 405 (shown in FIG. 4 as code cache memory 405). The instruction cache memory 405 is accordingly connected directly (that is, not via the checking unit 404) to ROM 402 and NVM 403.

In this embodiment, the program code portions are not checked when they are loaded into the instruction cache memory 405, but rather the program code portions are loaded into the instruction cache memory 405, the checking unit 404 computes the check value by way of read access to the instruction cache memory 405 and, in the event of a successful check of a program code portion, the CPU executes it (from the instruction cache memory 405).

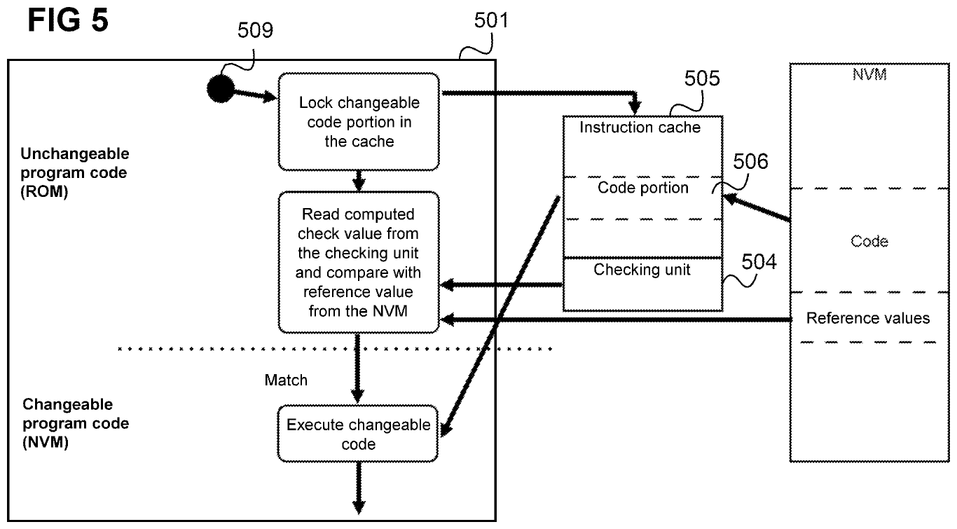

FIG. 5 shows a variant in which the CPU 501 performs the comparison between the check value supplied by the checking unit 504 (in this example implemented as part of the instruction cache memory 505) and the associated reference value.

In this case, FIG. 5 illustrates the checking of a first program code portion 506 following the startup 509 of the data processing device.

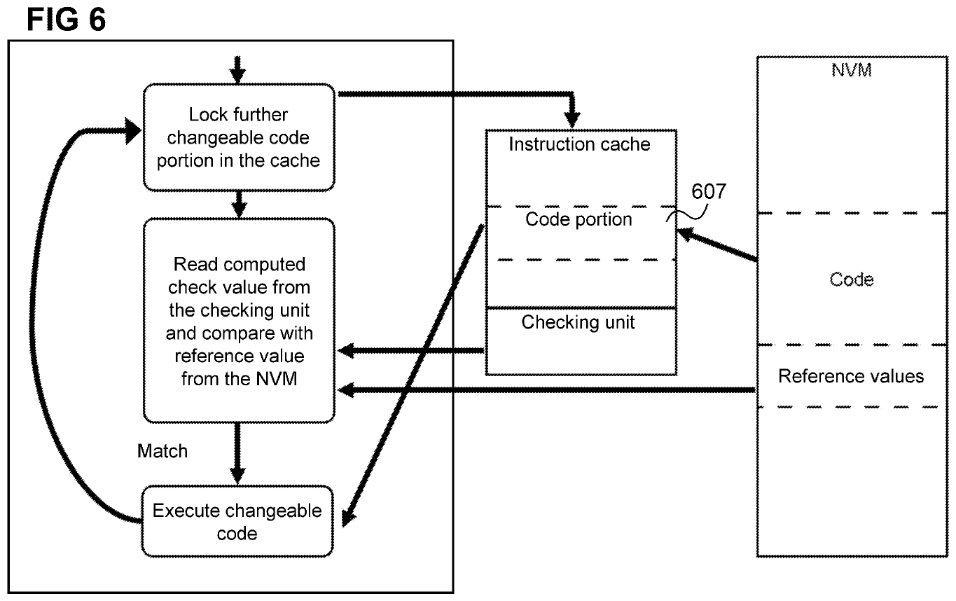

FIG. 6 illustrates the checking of a further program code portion 607 following the checking of the first program code portion 506 from FIG. 5.

Provision is made for the CPU to perform the comparison, as in FIG. 5 and FIG. 6, for example (only) when the reference value is write-protected.

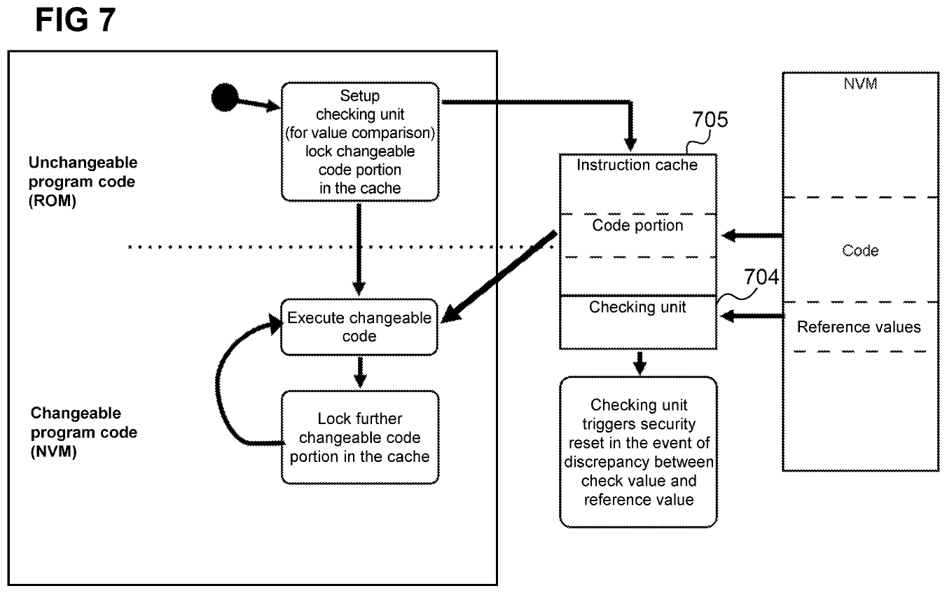

FIG. 7 shows a variant in which the checking unit 704 is implemented as part of the instruction cache memory 705 and carries out the check value computation and the comparison with the reference value.

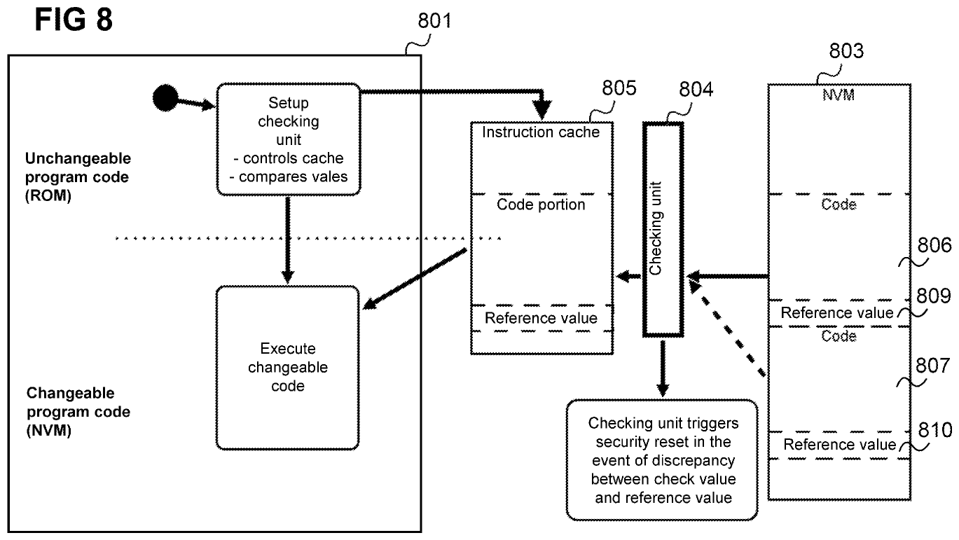

FIG. 8 shows a variant in which, for each program code portion 806, 807, a respective reference value 809, 810 is contained together with the program code portion 806, 807 in the NVM 803, such that it is loaded into the instruction cache memory 805 together with the program code portion 806, 807. The checking unit 804 may then access the reference value stored in the instruction cache memory 805 for the comparison when it has computed the check value for the program code portion.

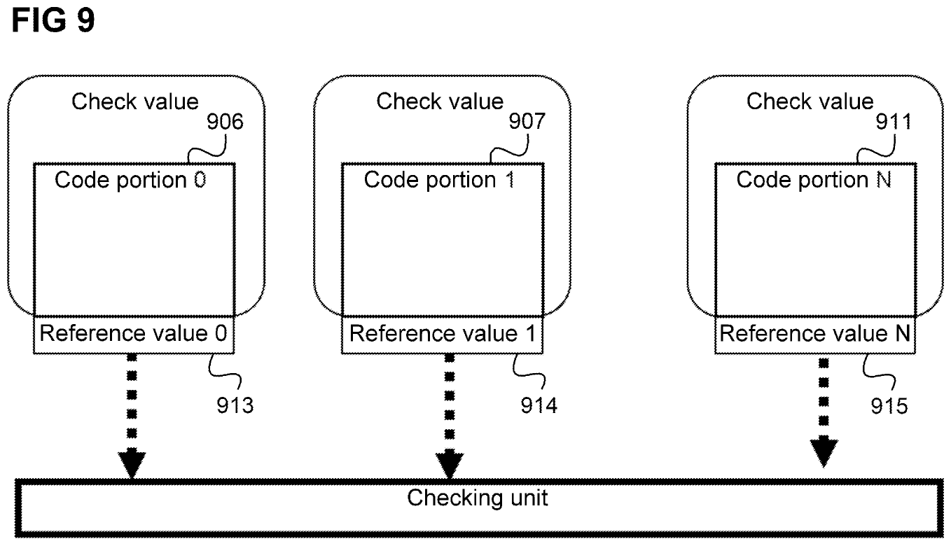

FIG. 9 illustrates an embodiment in which each program code portion 906, 907, 911 is provided with a respective reference value 913, 914, 915 that is stored together therewith (that is, as part thereof).

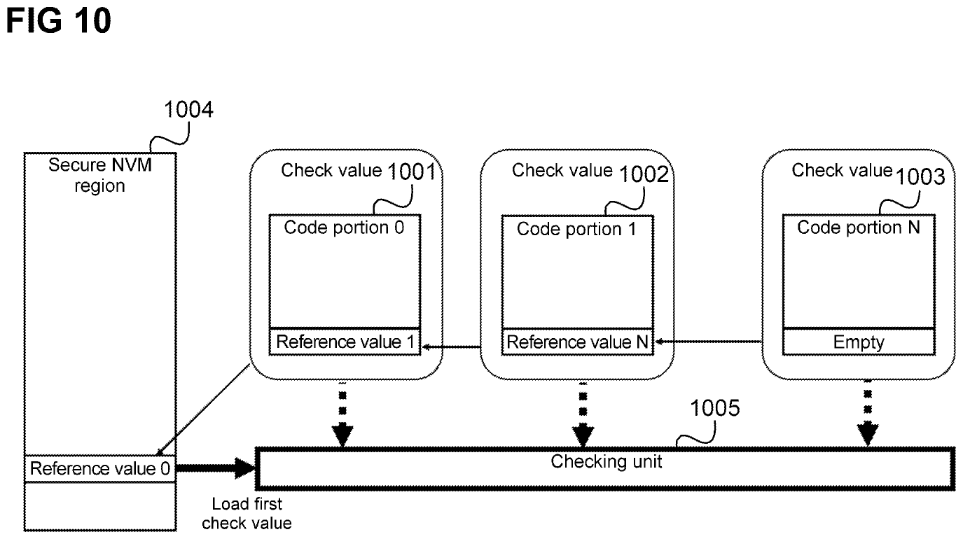

FIG. 10 illustrates an embodiment in which a first program code portion 1001 is provided with the reference value for a second program code portion 1002 and the second program code portion 1002 is provided with the reference value for a third program code portion 1003 (and generally so on until the nth, this is, last, program code portion). The last program code portion 1003 is not provided with a reference value. The reference value for the first program code portion 1001 is stored separately from the program code portions 1001, 1003, 1003, here in a secure NVM memory region 1004.

In this case, the checking unit 1005 may compute the check value for the code portion including the reference value with which the code portion is provided. The reference value is thereby also protected against manipulation.

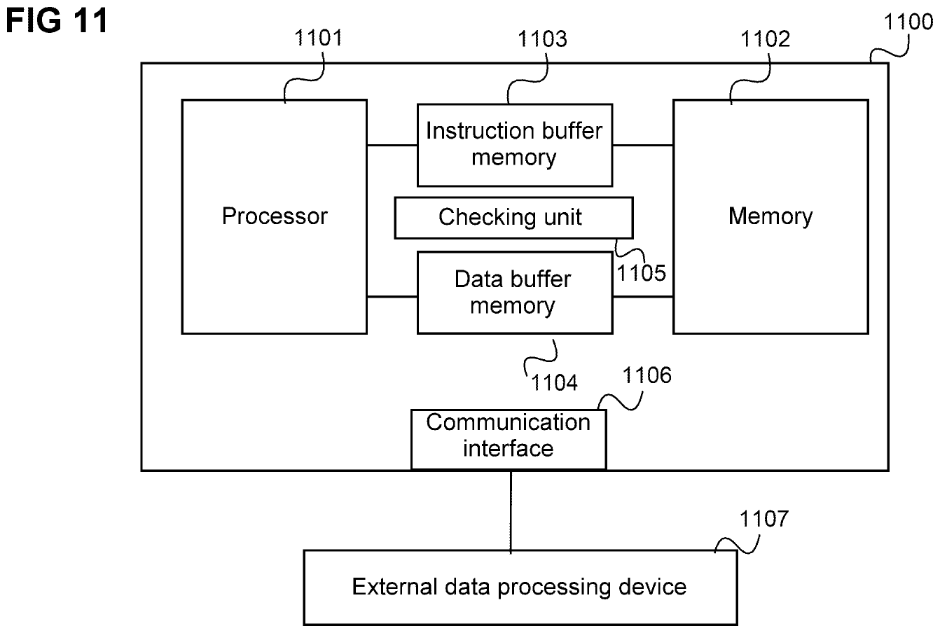

In summary, according to various embodiments, provision is made for a data processing device as illustrated in FIG. 11.

FIG. 11 shows a data processing device 1100 according to one embodiment.

The data processing device 1100 has a processor 1101, one or more memories 1102 that are configured to store multiple program instructions and data to be processed by a processor of the data processing device, an instruction buffer memory 1103 for buffer-storing the program instructions to be executed by the processor 1101 and a data buffer memory 1104 for buffer-storing the data to be processed.

The data processing device 1100 furthermore has a communication interface 1106 to an external data processing device 1107, which communication interface is configured to receive a reference value for a check of the multiple program instructions from the external data processing device 1107.

The data processing device 1100 furthermore has a checking unit 1105 that is configured to compute a check value for the check when the program instructions are loaded from the one or more memories 1102 into an instruction buffer memory 1103 of the data processing device or by way of read access to the instruction buffer memory 1103 after the program instructions have been loaded into the instruction buffer memory from the one or more memories 1102.

The processor 1101 is configured to execute at least some of the program instructions if the check value matches the received reference value.

The external data processing device 1107 is external in relation to the data processing device 1100, that is, they are separate devices, for example in separate housings. By way of example, the reference value may be linked to the external data processing device 1107 via the communication interface 1106 (for example via corresponding contacts or else contactlessly) when the data processing device 1100 is manufactured (for example before delivery to a customer), and it may receive and store (beforehand) the reference value. By way of example, the data processing device 1100 may receive the reference value together with the program instructions (that is, program code) and then ensure during operation that the program instructions are not changed. To this end, it stores the reference value in for example a write-protected (possibly secure) memory region.

The instruction buffer memory and the data buffer memory do not necessarily need to be implemented by way of separate memories (for example memory chips); they may also be (separate) memory regions of a memory (or of a memory arrangement).

The instruction buffer memory and the data buffer memory are for example buffer memories at least in the sense that they are volatile memories, while the memory (which may have multiple memory devices) is for example a non-volatile memory. The instruction buffer memory is for example a buffer memory dedicated to buffer-storing instructions (that is, program instructions) and the data buffer memory is for example a buffer memory dedicated to storing data to be processed (that is, data that are not executed as instructions by the processor, that is, do not specify processor instructions that the processor executes, but rather that are processed by executed processor instructions).

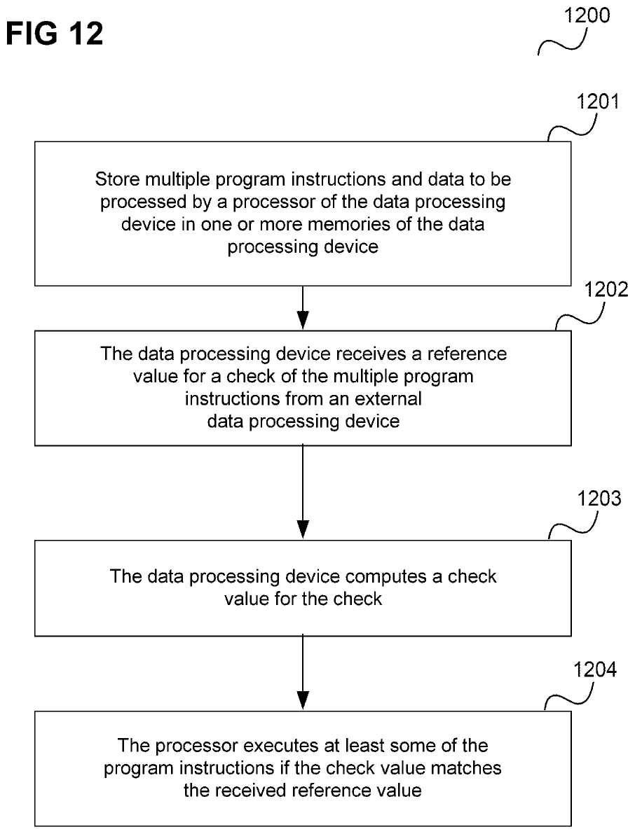

FIG. 12 shows a flowchart illustrating a method for executing a program on a data processing device.

In 1201, multiple program instructions and data to be processed by a processor of the data processing device are stored in one or more memories of the data processing device.

In 1202, the data processing device receives a reference value for a check of the multiple program instructions from an external data processing device and stores said reference value.

In 1203, a check value for the check is computed by the data processing device from the multiple program instructions when the program instructions are loaded from the one or more memories into an instruction buffer memory of the data processing device or by way of read access to the instruction buffer memory after the program instructions have been loaded into the instruction buffer memory from the one or more memories.

In 1204, at least some of the program instructions are executed by the processor if the check value matches the received reference value.

The data processing device may be configured such that the reference value and the check value are not able to be generated by the user of the data processing device, for example. According to one embodiment, this includes the check value that is computed in the data processing device (that is, in the checking unit) not being known to the processor or to an executed program and to the user.

Various example embodiments are stated below.
Example embodiment 1 is a method for executing a program on a data processing device, as described with reference to FIG. 12.
Example embodiment 2 is a method according to Example embodiment 1, comprising storing the reference value in a write-protected memory region of the data processing device.
Example embodiment 3 is a method according to Example embodiment 1 or 2, wherein the check value is a cryptographic check value.
Example embodiment 4 is a method according to one of Example embodiments 1 to 3, wherein the check value is derived from a key concealed in the data processing device.
Example embodiment 5 is a method according to one of Example embodiments 1 to 4, comprising computing the check value when the program instructions are loaded from the one or more memories into the instruction buffer memory by way of read access to a transmission path between the one or more memories and the instruction buffer memory.
Example embodiment 6 is a method according to one of Example embodiments 1 to 5, comprising storing the reference value in a write-protected memory region of the data processing device and the processor comparing the check value with the reference value.
Example embodiment 7 is a method according to one of Example embodiments 1 to 5, comprising a checking unit, which computes the check value, comparing the check value with the reference value.
Example embodiment 8 is a method according to one of Example embodiments 1 to 7, comprising outputting a signal and/or performing a security measure if the check value does not match the reference value.
Example embodiment 9 is a method according to one of Example embodiments 1 to 8, wherein a respective reference value is received for each of multiple program code portions each containing multiple program instructions of a program, a check value is computed when the program code portion is loaded into the instruction buffer memory or by way of read access to the instruction buffer memory after the program code portion has been loaded into the instruction buffer memory, and wherein, for each of the multiple program code portions, at least part of the program code portion is executed by the processor if the check value computed for the program code portion matches the reference value received for the program code portion.
Example embodiment 10 is a data processing device as described with reference to FIG. 11. Example embodiment 11 is a data processing device according to Example embodiment 10, wherein the instruction buffer memory has access for the processor that is faster in comparison with the one or more memories.
Example embodiment 12 is a data processing device according to Example embodiment 10 or 11, wherein the checking unit is configured to compare the check value with the reference value and to output a signal to another component of the data processing device if the check value does not match the reference value.
Example embodiment 13 is a data processing device according to one of Example embodiments 10 to 12, wherein the instruction buffer memory is a cache memory or a tightly coupled RAM.

Although the invention has been shown and described primarily with reference to specific embodiments, it should be understood by those familiar with the technical field that numerous modifications may be made with regard to configuration and details thereof, without departing from the essence and scope of the invention as defined by the claims hereinafter. The scope of the invention is therefore determined by the appended claims, and the intention is for all modifications to be encompassed which come under the literal meaning or the scope of equivalence of the claims.

### REFERENCE SIGNS

100 Data processing device
101 CPU
102 ROM
103 NVM
104 RAM
105 Instruction cache
106 Data cache
200 Data processing device
201 CPU
202 ROM
203 NVM
204 Checking unit
205 Instruction cache
301 CPU
303 NVM
304 Checking unit
305 Instruction cache
306, 307 Program code portions
308 Write-protected NVM regions
400 Data processing device
401 CPU
402 ROM
403 NVM
404 Checking unit
405 instruction cache
501 CPU
504 Checking unit
505 Instruction cache
506 Program code portion
509 Startup of the data processing device
607 Further program code portion
704 Transmission unit
705 Instruction cache
803 NVM
804 Checking unit
805 Instruction cache memory
806, 807 Program code portions
809, 810 Reference values
906, 907, 911 Program code portions
912-914 Reference values
1001-1003 Program code portions
1004 Secure NVM memory region
1005 Checking unit
1100 Data processing device
1101 Processor
1102 Memory
1103 Instruction buffer memory
1104 Data buffer memory
1105 Checking unit
1106 Communication interface
1107 External data processing device
1200 Flowchart
1201-1204 Sequence steps

What is claimed is:

1. A method for executing a program on a data processing device, the method comprising:
storing multiple program instructions and data to be processed by a processor of the data processing device in one or more memories of the data processing device;
the data processing device receiving, from an external data processing device, a reference value for a check of the multiple program instructions and storing the reference value in the data processing device;
computing a check value from the multiple program instructions for the check by way of the data processing device when the program instructions are loaded from the one or more memories into an instruction buffer memory of the data processing device or by way of read access to the instruction buffer memory after the program instructions have been loaded into the instruction buffer memory from the one or more memories; and
the processor executing at least some of the program instructions if the check value matches the received reference value.

2. The method of claim 1, comprising storing the reference value in a write-protected memory region of the data processing device.

3. The method of claim 1, wherein the check value is a cryptographic check value.

4. The method of claim 1, wherein the check value is derived from a key concealed in the data processing device.

5. The method of claim 1, comprising computing the check value when the program instructions are loaded from the one or more memories into the instruction buffer memory by way of read access to a transmission path between the one or more memories and the instruction buffer memory.

6. The method of claim 1, comprising storing the reference value in a write-protected memory region of the data processing device and the processor comparing the check value with the reference value.

7. The method of claim 1, comprising a checking unit, which computes the check value, comparing the check value with the reference value.

8. The method of claim 1, comprising outputting a signal and/or performing a security measure if the check value does not match the reference value.

9. The method of claim 1, wherein a respective reference value is received for each of multiple program code portions each containing multiple program instructions of a program, a check value is computed when the program code portion is loaded into the instruction buffer memory or by way of read access to the instruction buffer memory after the program code portion has been loaded into the instruction buffer memory, and wherein, for each of the multiple program code portions, at least part of the program code portion is executed by the processor if the check value computed for the program code portion matches the reference value received for the program code portion.

10. A data processing device comprising:
a processor;
one or more memories that are configured to store multiple program instructions and data to be processed by a processor of the data processing device;
an instruction buffer memory for buffer-storing the program instructions to be executed by the processor;
a data buffer memory for buffer-storing the data to be processed;
a communication interface to an external data processing device, which communication interface is configured to receive a reference value for a check of the multiple program instructions from the external data processing device and to store said reference value in the one or more memories; and
checking circuitry configured to compute a check value from the program instructions for the check when the program instructions are loaded from the one or more memories into an instruction buffer memory of the data processing device or by way of read access to the instruction buffer memory after the program instructions have been loaded into the instruction buffer memory from the one or more memories;
wherein the processor is configured to execute at least some of the program instructions if the check value matches the received reference value.

11. The data processing device of claim 10, wherein the instruction buffer memory has access for the processor that is faster in comparison with the one or more memories.

12. The data processing device of claim 10, wherein the checking unit is configured to compare the check value with the reference value and to output a signal to another component of the data processing device if the check value does not match the reference value.

13. The data processing device of claim 10, wherein the instruction buffer memory is a cache memory or a tightly coupled RAM.
